(19) United States
(12) Patent Application Publication
(10) Pub. No.: US 2025/0096221 A1
(43) Pub. Date: Mar. 20, 2025

(54) ALL-SOLID-STATE BATTERY CAPABLE OF OPERATING AT ROOM TEMPERATURE UNDER LOW PRESSURE AND MANUFACTURING METHOD THEREOF

(71) Applicants: Hyundai Motor Company, Seoul (KR); Kia Corporation, Seoul (KR); Seoul National University R&DB Foundation, Seoul (KR)

(72) Inventors: Ji Young Kim, Suwon-si (KR); Sam Ick Son, Suwon-si (KR); Ki Yoon Bae, Seoul (KR); Jang Wook Choi, Seoul (KR); Ji Hoon Oh, Seoul (KR)

(21) Appl. No.: 18/599,552

(22) Filed: Mar. 8, 2024

(30) Foreign Application Priority Data
Sep. 14, 2023 (KR) 10-2023-0122382

(51) Int. Cl. H01M 4/04; H01M 4/02; H01M 4/62; H01M 10/04; H01M 10/0562; H01M 10/0585

(52) U.S. Cl. CPC H01M 4/0404; H01M 4/0471; H01M 4/622; H01M 4/625; H01M 10/0468; H01M 10/0562; H01M 10/0585; H01M 2004/027

(57) ABSTRACT

An embodiment all-solid-state battery includes an anode current collector, a double layer disposed on the anode current collector, a solid electrolyte layer disposed on the double layer, the solid electrolyte layer including a solid electrolyte, a cathode layer disposed on the solid electrolyte layer, the cathode layer including a cathode active material, and a cathode current collector disposed on the cathode layer, wherein the double layer includes a protective layer disposed on the anode current collector and a metal alloy layer disposed on the protective layer, wherein the protective layer includes a reaction product of a conductive material containing a first functional group and a binder containing a second functional group, and wherein the metal alloy layer includes a metal capable of forming an alloy with lithium.

### CROSS-REFERENCE TO RELATED APPLICATIONS

This application claims the benefit of Korean Patent Application No. 10-2023-0122382, filed on Sep. 14, 2023, which application is hereby incorporated herein by reference.

### TECHNICAL FIELD

The present disclosure relates to an all-solid-state battery capable of operating at room temperature under low pressure and a method of manufacturing the same.

### BACKGROUND

Lithium-ion batteries are widely used in various devices that require energy storage. Depending on the field of application, various battery characteristics are required, such as high energy density, long cycle life, fast charging and discharging, high/low-temperature battery operation performance, and the like.

Recently, in order to solve environmental problems caused by carbon dioxide (CO₂), the use of fossil fuels has been avoided, so the industry of automobiles as means for transportation is showing great interest in electric vehicles that use secondary batteries. Currently developed lithium-ion batteries may travel approximately 400 km on a single charge, but problems such as instability at high temperatures, fire, etc. still occur. In order to solve these problems, many companies are competitively developing next-generation secondary batteries.

All-solid-state batteries, which are receiving attention as next-generation secondary batteries, have all components made of solids, so they have less risk of fire and explosion and have higher mechanical strength than lithium-ion batteries that use flammable organic solvents as electrolytes. The all-solid-state battery generally includes a cathode active material layer bonded to a cathode current collector, an anode active material layer bonded to an anode current collector, and a solid electrolyte layer interposed between the cathode active material layer and the anode active material layer.

The anode active material layer is formed by mixing an anode active material such as graphite or silicon with a solid electrolyte for lithium ion (Li⁺) conduction. Since the solid electrolyte has specific gravity greater than the liquid electrolyte, the conventional all-solid-state battery has the disadvantage of having low energy density compared to lithium-ion batteries.

With the goal of solving this problem, a storage-type anodeless all-solid-state battery has been devised in which the anode active material layer of an all-solid-state battery is eliminated or only a small amount of anode active material is used and lithium ions (Li⁺) are directly precipitated as lithium metal or lithium alloy on the anode current collector.

Anodeless all-solid-state batteries do not use anode active materials capable of storing lithium ions. During charging, lithium ions (Li⁺) released from the cathode active material layer are converted into lithium metal by reduction with electrons on the surface of the anode current collector through the solid electrolyte layer. During discharging, an opposite electrochemical reaction occurs. Briefly, an anodeless all-solid-state battery may be charged and discharged even without an anode active material.

For reversible charging and discharging of an anodeless all-solid-state battery, lithium metal has to be uniformly precipitated on the surface of the anode current collector and growth of lithium dendrites has to be suppressed during charging.

However, due to the irregular surface of the solid electrolyte layer and hardness of the anode current collector, voids are created between the solid electrolyte layer and the anode current collector, making it difficult for lithium metal to be uniformly precipitated. Therefore, for operation of an anodeless all-solid-state battery, high temperature and/or high pressure must be applied thereto.

### SUMMARY

The present disclosure relates to an all-solid-state battery capable of operating at room temperature under low pressure and a method of manufacturing the same. Particular embodiments relate to an all-solid-state battery capable of operating at room temperature under low pressure and a method of manufacturing the same, in which the all-solid-state battery includes a protective layer disposed on an anode current collector layer and having superior electrode adhesion and a lithium alloy layer disposed on the protective layer and alloying with lithium metal, thereby enabling operation thereof at room temperature under low pressure.

Embodiments of the present disclosure have been made keeping in mind the problems encountered in the related art and provide an all-solid-state battery capable of operating at room temperature under low pressure and a method of manufacturing the same.

In addition, embodiments of the present disclosure provide an all-solid-state battery and a method of manufacturing the same, in which a double layer including a material having high ductility may be interposed between a solid electrolyte layer and an anode current collector, thereby actively responding to volume changes that occur during charging and discharging of the all-solid-state battery.

The embodiments of the present disclosure are not limited to the foregoing. The embodiments of the present disclosure will be able to be clearly understood through the following description and to be realized by the means described in the claims and combinations thereof.

An embodiment of the present disclosure provides an all-solid-state battery, including an anode current collector, a double layer disposed on the anode current collector, a solid electrolyte layer disposed on the double layer and including a solid electrolyte, a cathode layer disposed on the solid electrolyte layer and including a cathode active material, and a cathode current collector disposed on the cathode layer, in which the double layer may include a protective layer disposed on the anode current collector and a metal alloy layer disposed on the protective layer and including a metal capable of forming an alloy with lithium, and the protective layer may include a reaction product of a conductive material containing a first functional group and a binder containing a second functional group.

In an embodiment, the conductive material may include at least one material selected from the group consisting of MXene, a layered carbon material, and combinations thereof.

Here, MXene may be represented by Chemical Formula 1 below.

Mₙ₊₁XₙTₛ Chemical Formula 1

In Chemical Formula 1, M includes a metal selected from the group consisting of transition metals belonging to Groups 3 to 6 in the periodic table and combinations thereof, X includes carbon (C) or nitrogen (N), Tₛ includes at least one functional group selected from the group consisting of a hydroxyl group (—OH), a carboxyl group (—COOH), and combinations thereof, and n is an integer of 1 to 3.

MXene may include Ti₃C₂Tₛ.

In an embodiment, the layered carbon material may include at least one material selected from the group consisting of graphene, graphene oxide, reduced graphene oxide, and combinations thereof, and the layered carbon material may include at least one functional group selected from among a hydroxyl group (—OH), a carboxyl group (—COOH), and combinations thereof formed on the surface thereof.

In an embodiment, the binder may include an imine polymer binder. Here, the binder may include at least one binder selected from the group consisting of linear polyethylenimine (l-PEI), branched polyethylenimine (b-PEI), and combinations thereof.

The binder may include branched polyethylenimine (b-PEI).

In an embodiment, the first functional group may include at least one functional group selected from the group consisting of a hydroxyl group (—OH), a carboxyl group (—COOH), and combinations thereof, the second functional group may include at least one functional group selected from the group consisting of a hydroxyl group (—OH), a carboxyl group (—COOH), an amino group (—NH₂), and combinations thereof, and the first functional group and the second functional group may be provided to enable dehydration condensation.

The first functional group may include a carboxyl group (—COOH), and the second functional group may include an amino group (—NH₂).

In an embodiment, the reaction product may include peptide bonding in at least a portion thereof.

In an embodiment, the thickness of the protective layer may be 1 μm to 50 μm.

In an embodiment, the metal may include at least one metal selected from the group consisting of magnesium (Mg), silver (Ag), zinc (Zn), gold (Au), and combinations thereof.

In an embodiment, electrode adhesion between the double layer and the anode current collector may be greater than 30 gf/mm.

Another embodiment of the present disclosure provides a method of manufacturing an all-solid-state battery, the method including preparing a slurry including a conductive material and a binder, forming an intermediate layer by applying the slurry onto an anode current collector, forming a protective layer by drying the intermediate layer, and assembling an all-solid-state battery configured such that the anode current collector, the protective layer, a metal alloy layer, a solid electrolyte layer, a cathode layer, and a cathode current collector are sequentially stacked, in which the conductive material may contain a first functional group, the binder may contain a second functional group, and the protective layer may include a reaction product of the conductive material and the binder.

In an embodiment, the temperature for drying of the intermediate layer may be 110° C. or higher.

In an embodiment, dehydration condensation may occur between the conductive material and the binder during drying of the intermediate layer.

In an embodiment, the amount of the binder may be 10 wt % to 20 wt %.

In an embodiment, the all-solid-state battery may be assembled by applying a fastening pressure of 5 MPa or less.

### BRIEF DESCRIPTION OF THE DRAWINGS

The above and other features of embodiments of the present disclosure will now be described in detail referring to certain exemplary embodiments thereof illustrated in the accompanying drawings, which are given hereinbelow by way of illustration only, and thus are not limitative of the embodiments of the present disclosure, and wherein:

FIG. 1 shows an all-solid-state battery according to embodiments of the present disclosure;

FIG. 2 shows the all-solid-state battery according to embodiments of the present disclosure that is charged;

FIG. 3 schematically shows a protective layer in which a conductive material, a binder, and a reaction product are distributed;

FIG. 4 schematically shows an enlarged side view of the dotted line area in FIG. 3;

FIG. 5 shows results of Fourier transform infrared (FTIR) analysis for a Preparation Example and MXene;

FIG. 6 is a graph showing results of evaluation of peel strength of the Preparation Example and a Comparative Preparation Example 3;

FIG. 7 is an enlarged view of the confidence interval in the graph of FIG. 6;

FIG. 8 shows results of evaluation of peel strength of the Preparation Example and Comparative Preparation Examples; and

FIG. 9 shows results of charging and discharging of half-cells according to an Example and a Comparative Example at room temperature under low pressure.

### DETAILED DESCRIPTION OF ILLUSTRATIVE EMBODIMENTS

The above and other objects, features, and advantages of embodiments of the present disclosure will be more clearly understood from the following preferred embodiments taken in conjunction with the accompanying drawings. However, the embodiments of the present disclosure are not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the embodiments of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the embodiments of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

### All-Solid-State Battery

An all-solid-state battery according to embodiments of the present disclosure may be an anodeless all-solid-state battery not including an anode active material. In order to reversibly charge and discharge an anodeless all-solid-state battery under conditions of room temperature and/or low pressure, the interface formed by the solid electrolyte layer with other components and the interface formed by the anode current collector with other components must be stable. Embodiments of the present disclosure pertain to an all-solid-state battery capable of operating under conditions of room temperature and/or low pressure by inserting a protective layer having superior adhesion and good ductility between the solid electrolyte layer and the anode current collector.

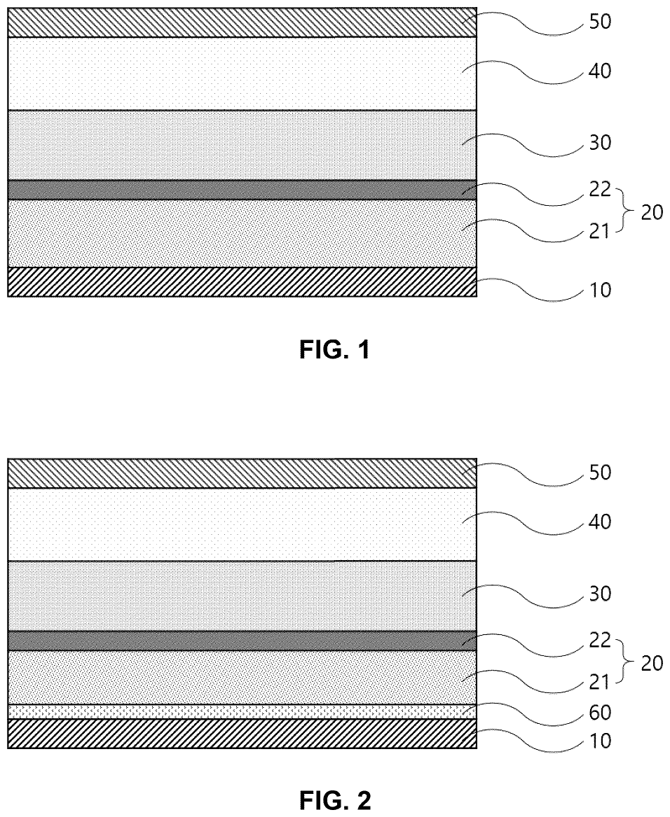

FIG. 1 shows an all-solid-state battery according to embodiments of the present disclosure. According to embodiments of the present disclosure, the all-solid-state battery includes an anode current collector 10, a double layer 20 disposed on the anode current collector 10, a solid electrolyte layer 30 disposed on the double layer 20 and including a solid electrolyte, a cathode layer 40 disposed on the solid electrolyte layer 30 and including a cathode active material, and a cathode current collector 50 disposed on the cathode layer 40, in which the double layer 20 may include a protective layer 21 disposed on the anode current collector 10 and a metal alloy layer 22 disposed on the protective layer 21 and including a metal capable of forming an alloy with lithium.

The anode current collector 10 may be a plate-type substrate having electrical conductivity. Specifically, the anode current collector 10 may be in the form of a sheet, a thin film, or a foil.

The anode current collector 10 may include a material that does not react with lithium. Specifically, the anode current collector 10 may include at least one material selected from the group consisting of nickel (Ni), copper (Cu), stainless steel, and combinations thereof.

The thickness of the anode current collector 10 is not particularly limited and may be, for example, 1 μm to 500 μm.

FIG. 2 shows the all-solid-state battery according to embodiments of the present disclosure that is charged. The all-solid-state battery that is charged may further include a precipitation layer 60 including lithium between the anode current collector 10 and the double layer 20. At the beginning of charging of the all-solid-state battery, lithium ions released from the cathode active material move to the double layer 20 through the solid electrolyte layer 30. The lithium ions are guided by the double layer 20 and are reduced between the anode current collector 10 and the double layer 20 to form the precipitation layer 60.

The protective layer 21 may have superior adhesion to the metal alloy layer 22 and the anode current collector 10. Also, the protective layer 21 may have high ductility and superior electrical conductivity.

Since the protective layer 21 has high adhesion to the metal alloy layer 22 and the anode current collector 10, even when high fastening pressure of tens to hundreds of MPa is not applied during assembly of the all-solid-state battery, stable operation thereof under low pressure is possible.

Since the protective layer 21 has high ductility, it is able to maintain a uniform interface with the anode current collector 10 when discharged. Also, the protective layer 21 has elasticity due to high ductility, so it is possible to minimize volume change due to formation of a precipitation layer. Here, high ductility of the protective layer 21 may be due to material properties of MXene or a layered carbon material included in the protective layer 21.

Meanwhile, the protective layer 21 may also contribute to forming a uniform interface between the metal alloy layer and the solid electrolyte layer 30. In the case in which the metal alloy layer is directly applied onto the anode current collector 10, it is difficult for the metal alloy layer to have ductility due to hardness of the anode current collector 10. Accordingly, voids may be formed in the interface between the metal alloy layer and the solid electrolyte layer 30. In this way, when contact between the metal alloy layer and the solid electrolyte layer 30 is poor, current may be intensively applied to a local portion in which the two components are in contact, forming lithium dendrites.

According to embodiments of the present disclosure, as the metal alloy layer is formed on the protective layer 21 having high ductility, a material having ductility may also be applied to the metal protective layer 21. Accordingly, the metal alloy layer may help to form a uniform interface with the solid electrolyte layer 30 and to suppress growth of lithium dendrites during charging and discharging.

The protective layer 21 according to embodiments of the present disclosure may include a reaction product of a conductive material containing a first functional group and a binder containing a second functional group. The protective layer 21 may further include at least one material selected from the group consisting of a conductive material, a binder, and combinations thereof, depending on the amounts, distribution, and reactivity of the conductive material and the binder introduced in the process of manufacturing the protective layer 21, as will be described later in the method of manufacturing an all-solid-state battery.

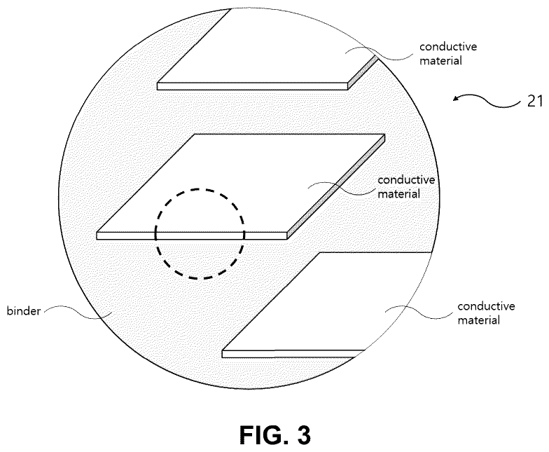

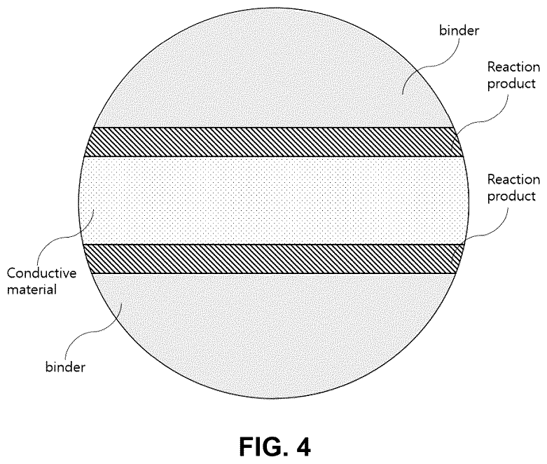

FIG. 3 schematically shows the protective layer 21 in which the conductive material, the binder, and the reaction product are distributed. FIG. 4 shows an enlarged side view of the dotted line area in FIG. 3.

Referring to FIG. 3, the conductive material included in the protective layer 21 may be physically connected by the binder. In FIG. 3, the conductive material is shown distributed on the binder, but depending on the amounts of the conductive material and the binder, the binder may be provided in the form of being loaded between the conductive material and the conductive material.

The conductive material has superior electrical conductivity and ductility and thus may contribute to electrical conductivity and ductility of the protective layer 21.

The first functional group is a functional group generally known in organic chemistry and may be a functional group capable of polymerization with the second functional group. For example, the first functional group may include at least one functional group selected from the group consisting of a hydroxyl group (—OH), a carboxyl group (—COOH), and combinations thereof.

The position in which the first functional group is contained in the conductive material is not particularly limited, but for example, the first functional group may be formed on the surface of the conductive material as shown in FIG. 4.

The binder may help the conductive material to be uniformly distributed within the protective layer 21 and may contribute to providing adhesion between the anode current collector 10 and the solid electrolyte layer 30 by the double layer 20 including the protective layer 21.

The second functional group is a functional group capable of polymerization with the first functional group and may include at least one functional group selected from the group consisting of, for example, a hydroxy group (—OH), a carboxyl group (—COOH), an amino group (—NH₂), and combinations thereof.

The reaction product may be formed by reaction of the conductive material containing the first functional group and the binder containing the second functional group with each other. Here, the reaction may be polymerization of the first functional group and the second functional group. The reaction product may be a polymer of the conductive material and the binder.

The reaction product may be formed on the surface of the conductive material as shown in FIG. 4. In FIG. 4, the conductive material, the binder, and the reaction product are shown to be mixed, but the area occupied by the reaction product may increase or decrease depending on factors such as the amounts, reactivity, and distribution of the conductive material and the binder. For example, only the reaction product may be present due to polymerization of all of the conductive material with the binder, only the reaction product and the binder may be present, or only the reaction product and the conductive material may be present.

The polymerization may typically include addition polymerization, condensation polymerization, or co-polymerization, and the polymerization between the first functional group and the second functional group may be condensation polymerization. Here, the reaction product may be a condensation polymer of the conductive material and the binder.

When the first functional group includes at least one functional group selected from the group consisting of a hydroxyl group (—OH), a carboxyl group (—COOH), and combinations thereof and when the second functional group includes at least one functional group selected from the group consisting of a hydroxyl group (—OH), a carboxyl group (—COOH), an amino group (—NH₂), and combinations thereof, the condensation polymerization may be dehydration condensation.

In an embodiment, the first reactive group may include a carboxyl group (—COOH), and the second reactive group may include an amino group (—NH₂). As such, the reaction product may include peptide bonding in at least a portion thereof.

In an embodiment, the conductive material may include at least one material selected from the group consisting of MXene, a layered carbon material, and combinations thereof.

MXene is a ceramic material with a layered structure and may be represented by Chemical Formula 1 below.

Mₙ₊₁XₙTₛ Chemical Formula 1

Here, X may be located within the octahedral array of M.

M may include a metal selected from the group consisting of transition metals belonging to Groups 3 to 6 in the periodic table and combinations thereof.

X may include carbon (C) or nitrogen (N).

Tₛ may include at least one functional group selected from the group consisting of a hydroxyl group (—OH), a carboxyl group (—COOH), and combinations thereof.

Also, n may be an integer of 1 to 3.

Specifically, M may include at least one material selected from among Sc, Y, Lu, Ti, Zr, Hf, V, Nb, Ta, Cr, Mo, and W. Also, Mₙ₊₁Xₙ may include Sc₂C, Ti₂C, V₂C, Cr₂C, Cr₂N, Zr₂C, Nb₂C, Hf₂C, Ti₃C₂, V₃C₂, Ta₃C₂, Ti₄C₃, V₄C₃, Ta₄C₃, or combinations or mixtures thereof. MXene may include Ti₃C₂Tₛ.

MXene having the composition of Mₙ₊₁XₙTₛ may be in a state in which a surface of a layer formed by MXene is modified by Tₛ. Here, Tₛ is the first functional group represented in the form of a chemical formula, is a functional group bound to the surface of the layer, and may be a hydrophilic surface functional group formed on the surface of the layer during selective etching.

Since MXene has superior electrical conductivity and high ductility, the protective layer 21 including the same may contribute to minimizing volume change due to the precipitation layer 60, forming a uniform interface between the metal alloy layer and the solid electrolyte layer 30, and forming a uniform interface between the protective layer 21 and the anode current collector 10.

In an embodiment, the layered carbon material may include at least one material selected from the group consisting of graphene, graphene oxide, reduced graphene oxide, and combinations thereof. Also, the layered carbon material may include at least one functional group selected from the group consisting of a hydroxyl group (—OH), a carboxyl group (—COOH), and combinations thereof formed on the surface thereof. Here, at least one functional group may be the first functional group.

The term “layered” may not mean having the shape of a layer or plate from a macroscopic perspective but may mean having a structure in which carbon atoms are gathered together to form a two-dimensional plane from a microscopic perspective.

The layered carbon material has a layered structure similar to MXene and has superior electrical conductivity, so it may similarly exhibit the above-described effects.

In an embodiment, the binder may be an amine polymer binder.

The amine polymer binder may mean that nitrogen (N) forms a single bond with any atom in a portion of the chemical formula of the binder.

The amine polymer binder may include linear polyethylenimine (l-PEI) and branched polyethylenimine (b-PEI). The use of branched polyethylenimine (b-PEI) is preferable.

Polyethylenimine may be a polymer having a repeat unit including an amine group and two carbon aliphatic CH₂CH₂ spacers. For example, polyethylenimine may include Repeat Unit 1 below.

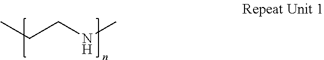

Linear polyethylenimine may be understood as containing only primary and secondary amino groups, and branched polyethylenimine may be understood as containing primary, secondary, and tertiary amino groups.

For example, linear polyethylenimine may include Repeat Unit 2 below, and branched polyethylenimine may include Repeat Unit 3 below.

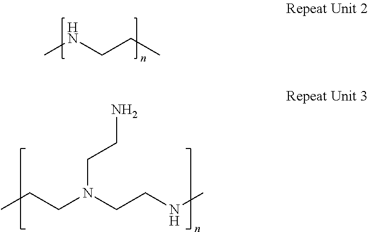

In addition, linear polyethylenimine and branched polyethylenimine may be applied in various ways, so long as they satisfy definitions of linear polyethylenimine and branched polyethylenimine. For example, branched polyethylenimine may include Repeat Unit 4 below.

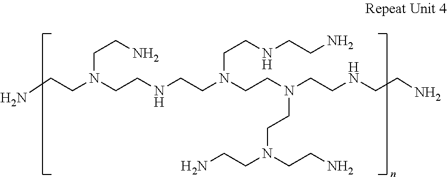

In an embodiment, the thickness of the protective layer 21 may be 1 μm to 50 μm. When the thickness of the protective layer 21 falls within the above numerical range, electrical conductivity and ductility are superior, and sufficient adhesion to the metal alloy layer and the anode current collector 10 may be provided.

If the thickness of the protective layer 21 is less than 1 μm, the protective layer may be excessively thin, making it difficult to properly respond to changes in the thickness of the metal alloy layer during charging and discharging of the battery and making it difficult to provide sufficient adhesion to the metal alloy layer and the anode current collector 10. On the other hand, if the thickness of the protective layer 21 exceeds 50 μm, energy density of the all-solid-state battery may be lowered.

In an embodiment, the metal may include at least one selected from the group consisting of magnesium (Mg), silver (Ag), zinc (Zn), gold (Au), and combinations thereof.

The thickness of the metal alloy layer 22 may be 10 nm to 1,000 nm. If the thickness of the metal alloy layer 22 is less than 10 nm, voids may be formed between the metal alloy layer 22 and the solid electrolyte layer 30. If the thickness of the metal alloy layer 22 exceeds 1,000 nm, irreversible capacity of the all-solid-state battery may increase.

In an embodiment, electrode adhesion between the double layer 20 and the anode current collector 10 may be greater than 30 gf/mm.

If electrode adhesion between the double layer 20 and the anode current collector 10 is 30 gf/mm or less, the anode current collector 10 and the double layer 20 may be easily separated due to continuous volume changes during charging and discharging of the all-solid-state battery. When the anode current collector 10 and the double layer 20 are easily separated in this way, high fastening pressure of tens to hundreds of MPa must be applied during assembly of the all-solid-state battery in order to prevent such separation.

The solid electrolyte layer 30 may be interposed between the cathode layer 40 and the double layer 20 and may include a solid electrolyte having lithium ion conductivity.

The solid electrolyte may include an oxide-based solid electrolyte, a sulfide-based solid electrolyte, and the like. The use of a sulfide-based solid electrolyte having high lithium ion conductivity is preferable. The sulfide-based solid electrolyte is not particularly limited, and examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y}(in which x and y are positive numbers, and M is any one selected from among P, Si, Ge, B, Al, Ga, and In), Li₁₀GeP₂S₁₂, and the like.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

The cathode layer may include a cathode active material, a solid electrolyte, a cathode conductive material, a binder, etc. The cathode active material is capable of intercalating and deintercalating lithium ions, and examples thereof may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}CO(_{0.2-x})AlₓO₂(0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like.

The solid electrolyte may include an oxide-based solid electrolyte or a sulfide-based solid electrolyte. The use of a sulfide-based solid electrolyte having high lithium ion conductivity is preferable. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like. The solid electrolyte included in the cathode layer may be the same as or different from the solid electrolyte included in the solid electrolyte layer 30.

Examples of the cathode conductive material may include carbon black, conductive graphite, ethylene black, graphene, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. Here, the binder included in the cathode layer may be different from the binder included in the protective layer.

The cathode current collector 50 may include a plate-type substrate having electrical conductivity. The cathode current collector 50 may include an aluminum foil.

The thickness of the cathode current collector 50 is not particularly limited and may be, for example, 1 μm to 500 μm.

### Method of Manufacturing All-Solid-State Battery

Another aspect of embodiments of the present disclosure pertains to a method of manufacturing an all-solid-state battery, the method including preparing a slurry including a conductive material and a binder, forming an intermediate layer by applying the slurry onto an anode current collector 10, forming a protective layer 21 by drying the intermediate layer, and assembling an all-solid-state battery configured such that the anode current collector 10, the protective layer 21, a metal alloy layer 22, a solid electrolyte layer 30, a cathode layer 40, and a cathode current collector 50 are sequentially stacked. Here, the conductive material may contain a first functional group, the binder may contain a second functional group, and the protective layer 21 may include a reaction product of the conductive material and the binder.

The slurry may be prepared by adding the conductive material and the binder to a solvent. The conductive material and the binder are as described above in the “All-solid-state battery” section. In addition, the layer including the protective layer 21 and the metal alloy layer 22 may be referred to as a double layer, and the description of the double layer 20 is as described above in the “All-solid-state battery” section.

The solvent may include at least one selected from the group consisting of N-methyl-2-pyrolidone, water, ethanol, isopropanol, and combinations thereof.

Thereafter, the slurry may be applied onto the anode current collector 10 to form an intermediate layer. Here, the slurry may be applied using a typical slurry casting process.

Alternatively, rather than directly applying the slurry onto the anode current collector 10, the slurry may be applied onto a release film to form an intermediate layer, which may then be dried to form the protective layer 21, followed by attaching the protective layer 21 to the anode current collector 10 by transfer, etc.

In an embodiment, the amount of the binder that is added to the slurry may be 10 wt % to 20 wt % based on 100 wt % of a sum of the binder and the conductive material. If the amount of the binder is less than 10 wt %, electrode adhesion between the double layer 20 and the anode current collector 10 may decrease. On the other hand, if the amount of the binder exceeds 20 wt %, electrical conductivity of the protective layer 21 may decrease.

After formation of the intermediate layer by applying the slurry onto the anode current collector 10, the protective layer 21 may be formed by drying the intermediate layer under temperature conditions sufficient to evaporate the solvent. During drying, the solvent may be removed from the slurry, and at the same time, a reaction product may be formed by polymerization of the first functional group of the conductive material included in the intermediate layer and the second functional group of the binder.

In this case, depending on the types of first and second functional groups, the polymerization may be condensation polymerization or dehydration condensation. When the polymerization is dehydration condensation, water and a reaction product may be formed during drying.

In an embodiment, the temperature for drying of the intermediate layer may be 110° C. or higher. When the polymerization is dehydration condensation, water produced by dehydration condensation may be removed by evaporation at a drying temperature of about 110° C. or higher. In addition, since water is evaporated and removed, forward reaction in which a reaction product is formed from the conductive material and the binder may be promoted without a separate catalyst based on Le Chatelier's principle.

The drying temperature of the intermediate layer is not particularly limited so long as the conductive material and the binder do not evaporate, and for example, may fall in the range of 110° C. to 500° C.

After formation of the protective layer 21 on the anode current collector 10 by drying, the metal alloy layer 22 may be formed by subjecting a metal capable of forming an alloy with lithium to deposition such as chemical vapor deposition (CVD) or physical vapor deposition (PVD). For example, the metal alloy layer 22 may be formed by sputtering.

Thereafter, a solid electrolyte layer 30, a cathode layer 40, and a cathode current collector 50 are deposited on the metal alloy layer 22 to form a stack configured such that the anode current collector 10, the protective layer 21, the metal alloy layer 22, the solid electrolyte layer 30, the cathode layer 40, and the cathode current collector 50 are sequentially stacked, after which predetermined fastening pressure is applied thereto, thereby assembling an all-solid-state battery. Here, the all-solid-state battery may be assembled by applying a relatively low fastening pressure of 5 MPa or less.

In this way, as the all-solid-state battery is assembled under a fastening pressure of 5 MPa or less, an all-solid-state battery capable of operating at room temperature under low pressure may be obtained.

In addition, the all-solid-state battery manufactured by the method of manufacturing the all-solid-state battery described above and the components included therein are substantially the same as those described above in the “All-solid-state battery” section, so a detailed description thereof will be omitted.

A better understanding of embodiments of the present disclosure may be obtained through the following examples and comparative examples. However, these examples are not construed as limiting the technical spirit of the present disclosure.

### Preparation Example

A slurry was prepared by adding MXene (Ti₃C₂Tₛ) containing —COOH groups on the surface and branched polyethylenimine respectively weighed at 90 wt % and 10 wt % to N-methyl-2-pyrrolidone as a solvent and performing mixing.

An intermediate layer was formed by applying the slurry onto a nickel (Ni) anode current collector 10, and was then dried at about 110° C. to form a protective layer 21 on the anode current collector 10.

Thereafter, the Preparation Example in which the protective layer 21 and the metal alloy layer 22 were stacked on the anode current collector 10 was obtained by sputtering magnesium (Mg) on the protective layer 21.

### Comparative Preparation Example 1

The Comparative Preparation Example 1 in which a protective layer 21 and a metal alloy layer 22 were stacked on an anode current collector 10 was obtained in the same manner as in the Preparation Example, with the exception that, during preparation of the slurry, MXene (Ti₃C₂Tₛ) and branched polyethylenimine were weighed at 93 wt % and 7 wt %, respectively.

### Comparative Preparation Example 2

The Comparative Preparation Example 2 in which a protective layer 21 and a metal alloy layer 22 were stacked on an anode current collector 10 was obtained in the same manner as in the Preparation Example, with the exception that, during preparation of the slurry, MXene (Ti₃C₂Tₛ) and branched polyethylenimine were weighed at 96 wt % and 4 wt %, respectively.

### Comparative Preparation Example 3

The Comparative Preparation Example 3 in which a protective layer 21 and a metal alloy layer 22 were stacked on an anode current collector 10 was obtained in the same manner as in the Preparation Example, with the exception that, during preparation of the slurry, polyvinylidene fluoride (PVDF) was used as a binder instead of branched polyethylenimine.

### Test Example 1—FTIR Analysis

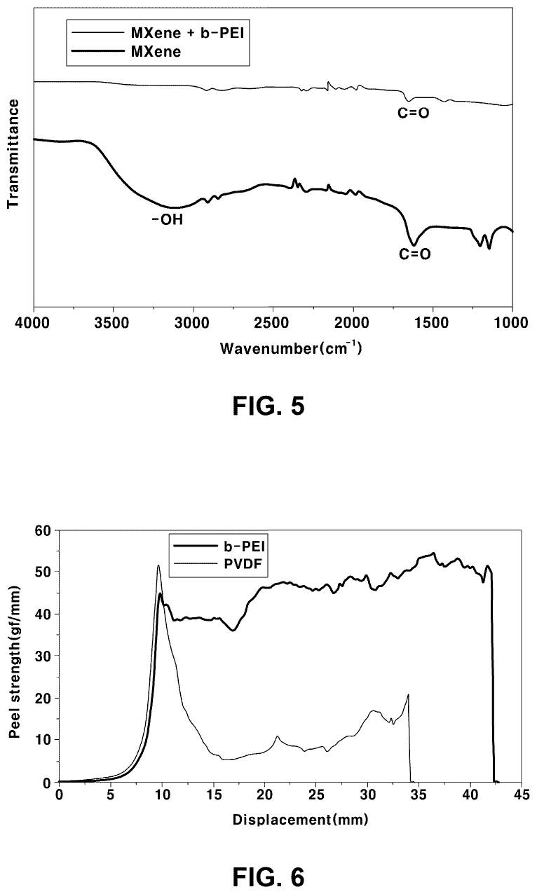

In order to determine whether a reaction product was formed by condensation polymerization of MXene (Ti₃C₂Tₛ) as a conductive material containing —COOH groups on the surface and branched polyethylenimine as a binder, FTIR (Fourier transform infrared) analysis of the Preparation Example was performed. The results thereof are shown in FIG. 5, and as a control, FTIR results of MXene (Ti₃C₂Tₛ) as a conductive material containing —COOH groups on the surface are also shown.

As shown in FIG. 5, for MXene that was not subjected to condensation polymerization, the —OH bond and the C═O double bond were confirmed due to the —COOH groups. On the other hand, in the results of FTIR analysis of the protective layer 21 of the Preparation Example, only the C═O double bond was observed. Based on the above results, it was confirmed that dehydration condensation occurred between the —COOH group of MXene and the —NH₂ group of branched polyethylenimine.

### Test Example 2—Evaluation of Peel Strength

In order to confirm electrode adhesion between the double layer 20 and the anode current collector 10 depending on the amount and type of binder, evaluation of peel strength was performed on the Preparation Example and the Comparative Preparation Examples 1 to 3.

Specifically, after fixing the surface of the anode current collector 10 of the Preparation Example and the Comparative Preparation Examples, a polyester film (polyethylene terephthalate film, backing film) with a thickness of 50 μm was attached to the surface of the double layer 20. After aging at 25° C. for 30 minutes, force by which the double layer 20 is peeled off at 90° at a speed of 2400 mm/min at 25° C. was measured using a Texture Analyzer (TA. XT_Plus, Stable Micro System).

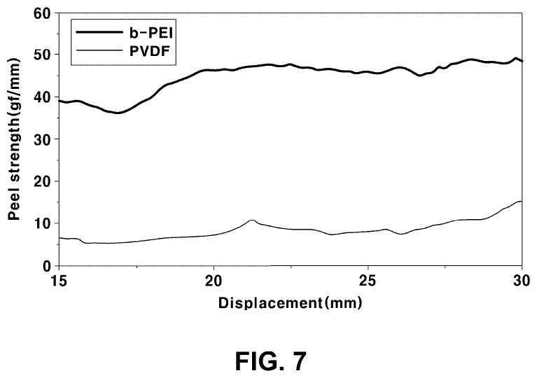

FIG. 6 shows results of evaluation of peel strength of the Preparation Example and the Comparative Preparation Example 3, and FIG. 7 shows the confidence interval (15 mm to 30 mm) extracted from FIG. 6.

Referring to FIGS. 6 and 7, peel strength of the Preparation Example was measured to be about 40 gf/mm, whereas peel strength of the Comparative Example 3 was measured to be about 5 gf/mm. Based on the above results, it was confirmed that electrode adhesion was higher when branched polyethylenimine was used as a binder than PVDF, which is commonly used as a binder.

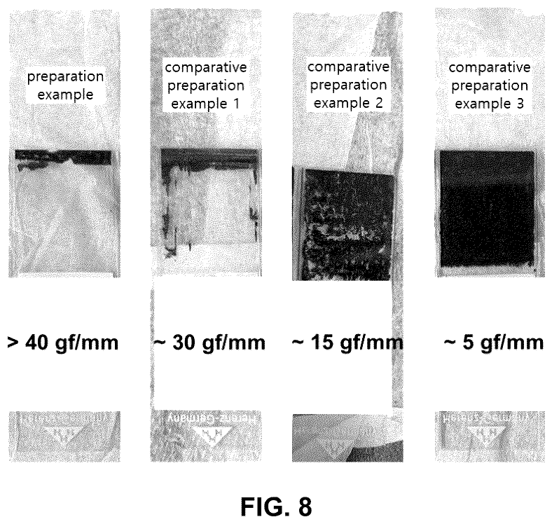

FIG. 8 shows images after evaluation of peel strength of the Preparation Example and the Comparative Preparation Examples 1 to 3, along with the results of peel strength values.

Referring to FIG. 8, peel strength of the Preparation Example was measured to be about 40 gf/mm, peel strength of the Comparative Preparation Example 1 was measured to be about 30 gf/mm, peel strength of the Comparative Preparation Example 2 was measured to be about 15 gf/mm, and peel strength of the Comparative Preparation Example 3 was measured to be about 5 gf/mm. Based on the above results, it was confirmed that peel strength decreased with a decrease in the amount of the branched polyethylenimine binder mixed in the slurry.

In addition, through the peeled appearance of the double layer 20, adhesion between the double layer 20 and the anode current collector 10 and cohesion of the double layer 20 were confirmed.

Specifically, referring to FIG. 8, when force corresponding to peel strength of each of the Preparation Example and the Comparative Preparation Examples was applied, all of the double layer 20 in the Preparation Example was maintained on the anode current collector 10, whereas a portion of the top of the double layer 20 was detached in the Comparative Preparation Example 1, most of the top of the double layer 20 was detached in the Comparative Preparation Example 2, and all of the top of the double layer 20 was detached in the Comparative Preparation Example 3.

The above results show that cohesion was strong in the order of the Preparation Example, the Comparative Preparation Example 1, the Comparative Preparation Example 2, and the Comparative Preparation Example 3.

### Example

A solid electrolyte layer 30 including a sulfide-based solid electrolyte was stacked on the double layer 20 according to the Preparation Example. The sulfide-based solid electrolyte used was Li₆PS₅Cl. A half-cell was manufactured by attaching lithium metal to the upper surface of the solid electrolyte layer 30, followed by pressing with a fastening pressure of 2 MPa.

### Comparative Example

A half-cell was manufactured in the same manner as in the Example, with the exception that a solid electrolyte layer 30 including a sulfide-based solid electrolyte was stacked on the double layer 20 according to the Comparative Preparation Example 3.

### Test Example 3—Evaluation of Electrochemical Performance

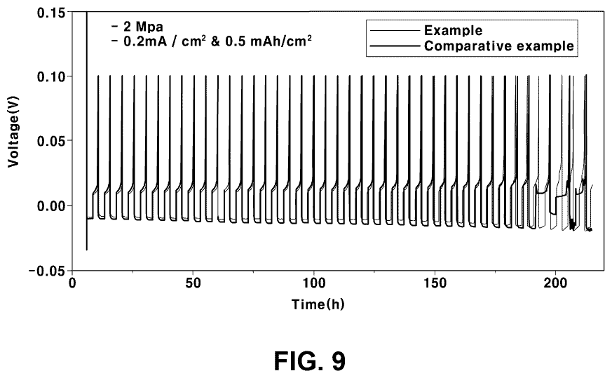

In order to evaluate performance depending on the type of binder used, electrochemical performance of the half-cells according to the Example and the Comparative Example was measured. Specifically, lithium symmetric cell evaluation was performed under conditions of a current density of 0.2 mAcm⁻² and a capacity per area of 0.5 mAhcm⁻², and the results thereof are shown in FIG. 9.

Referring to FIG. 9, the Example according to embodiments of the present disclosure showed less overvoltage characteristics than the Comparative Example. In the Comparative Example, deterioration of the half-cell was observed at about 195 hours, but no deterioration was observed in the half-cell according to the Example within the evaluation range.

As is apparent from the above description, according to embodiments of the present disclosure, a protective layer including a reaction product of a conductive material containing a first functional group and a binder containing a second functional group can be disposed between an anode current collector and a metal alloy layer, thereby obtaining an all-solid-state battery capable of operating at room temperature under low pressure.

In addition, according to embodiments of the present disclosure, a protective layer including MXene or a layered carbon material with high elasticity and ductility can be interposed between the metal alloy layer and the anode current collector, thus actively responding to volume changes during charging and discharging of the all-solid-state battery, ultimately improving durability of the all-solid-state battery.

In addition, water is produced by dehydration condensation of the first functional group and the second functional group and is evaporated during drying of an intermediate layer, making it easy to convert the intermediate layer into the protective layer without a separate catalyst.

The effects of embodiments of the present disclosure are not limited to the above-mentioned effects. It should be understood that the effects of embodiments of the present disclosure include all effects that can be inferred from the description of the embodiments of the present disclosure.

As the test examples and examples of embodiments of the present disclosure have been described in detail above, the scope of the embodiments of the present disclosure is not limited to the above-described test examples and examples, and various modifications and improvements made by those skilled in the art using the basic concept of the embodiments of the present disclosure defined in the following claims are also within the scope of the embodiments of the present disclosure.

What is claimed is:

1. An all-solid-state battery comprising:
an anode current collector;
a double layer disposed on the anode current collector, wherein the double layer comprises:
a protective layer disposed on the anode current collector, the protective layer comprising a reaction product of a conductive material containing a first functional group and a binder containing a second functional group; and
a metal alloy layer disposed on the protective layer, the metal alloy layer comprising a metal capable of forming an alloy with lithium;
a solid electrolyte layer disposed on the double layer, the solid electrolyte layer comprising a solid electrolyte;
a cathode layer disposed on the solid electrolyte layer, the cathode layer comprising a cathode active material; and
a cathode current collector disposed on the cathode layer.

2. The all-solid-state battery of claim 1, wherein the conductive material comprises one selected from the group consisting of an MXene, a layered carbon material, and a combination thereof.

3. The all-solid-state battery of claim 2, wherein the MXene is represented by:
Mₙ₊₁XₙTₛ
wherein M comprises a metal selected from the group consisting of transition metals belonging to Groups 3 to 6 in a periodic table and combinations thereof, X comprises carbon or nitrogen, Ts comprises a functional group selected from the group consisting of a hydroxyl group (—OH), a carboxyl group (—COOH), and a combination thereof, and n is an integer of 1 to 3.

4. The all-solid-state battery of claim 2, wherein the MXene comprises Ti₃C₂Tₛ.

5. The all-solid-state battery of claim 2, wherein the layered carbon material comprises:
a carbon material selected from the group consisting of graphene, graphene oxide, reduced graphene oxide, and a combination thereof; and
the layered carbon material comprises at least one functional group selected from among a hydroxyl group (—OH) and a carboxyl group (—COOH) on a surface thereof.

6. The all-solid-state battery of claim 1, wherein the binder comprises an amine polymer binder.

7. The all-solid-state battery of claim 1, wherein the binder comprises one selected from the group consisting of linear polyethylenimine (l-PEI), branched polyethylenimine (b-PEI), and a combination thereof.

8. The all-solid-state battery of claim 1, wherein:
the first functional group comprises one selected from the group consisting of a hydroxyl group (—OH), a carboxyl group (—COOH), and a combination thereof;
the second functional group comprises one selected from the group consisting of the hydroxyl group (—OH), the carboxyl group (—COOH), an amino group (—NH₂), and a combination thereof; and
the first functional group and the second functional group are configured to enable dehydration condensation.

9. The all-solid-state battery of claim 1, wherein the first functional group comprises a carboxyl group (—COOH), and the second functional group comprises an amino group (—NH₂).

10. The all-solid-state battery of claim 1, wherein the reaction product comprises peptide bonding in at least a portion thereof.

11. The all-solid-state battery of claim 1, wherein a thickness of the protective layer is 1 μm to 50 μm.

12. The all-solid-state battery of claim 1, wherein the metal comprises one selected from the group consisting of magnesium, silver, zinc, gold, and a combination thereof.

13. The all-solid-state battery of claim 1, wherein electrode adhesion between the double layer and the anode current collector is greater than 30 gf/mm.

14. A method of manufacturing an all-solid-state battery, the method comprising:
preparing a slurry comprising a conductive material and a binder, wherein the conductive material comprises a first functional group and the binder comprises a second functional group;
forming an intermediate layer by applying the slurry onto an anode current collector;
forming a protective layer by drying the intermediate layer, wherein the protective layer comprises a reaction product of the conductive material and the binder; and
assembling the all-solid-state battery configured such that the anode current collector, the protective layer, a metal alloy layer, a solid electrolyte layer, a cathode layer, and a cathode current collector are sequentially stacked.

15. The method of claim 14, wherein drying the intermediate layer is performed at a temperature of 110° C. or higher.

16. The method of claim 14, wherein dehydration condensation occurs between the conductive material and the binder during the drying of the intermediate layer.

17. The method of claim 14, wherein an amount of the binder is 10 wt % to 20 wt %.

18. The method of claim 14, wherein the all-solid-state battery is assembled by applying a fastening pressure of 5 MPa or less.

19. The method of claim 14, wherein the conductive material comprises one selected from the group consisting of an MXene, a layered carbon material, and a combination thereof.

20. The method of claim 14, wherein the binder comprises one selected from the group consisting of linear polyethylenimine (l-PEI), branched polyethylenimine (b-PEI), and a combination thereof.
